(19) United States
(12) Patent Application Publication
(10) Pub. No.: US 2021/0364071 A1
(43) Pub. Date: Nov. 25, 2021

(54) APPARATUS AND METHOD FOR CONVERTING CENTRIFUGAL FORCE TO A UNIDIRECTIONAL FORCE

(71) Applicant: INTELLITCH PTY LTD, Malvern (AU)

(72) Inventors: Alexander Mostovoy, Ashkelon (IL); Victor Shlakhetski, Ashkelon (IL)

(73) Assignee: INTELLITCH PTY LTD, Malvern (IL)

(21) Appl. No.: 17/050,021

(22) PCT Filed: Apr. 17, 2019
(86) PCT No.: PCT/IL2019/050434

§ 371 Date: Oct. 23, 2020

(30) Foreign Application Priority Data
Apr. 26, 2018 (IL) 258954

(51) Int. Cl. F16H 33/20; F16H 35/18

(52) U.S. Cl. CPC F16H 33/20; F16H 35/18

(57) ABSTRACT

A centrifugal force converting apparatus and a method for converting centrifugal force to a unidirectional force. The centrifugal force converting apparatus may include a curvilinear, variable-radius continuous track along which a roller is urged to traverse during rotation of a vertical shaft; a displaceable platform connected to the track; a linear guide connected to the shaft along which a single weighted carriage connected to the roller is slidable; and a speed controller for controllably varying rotational speed of the shaft.

### CROSS REFERENCE TO RELATED APPLICATIONS

This application claims priority to Israel Application No. 258,954, filed Apr. 26, 2018, the entirety of which is incorporated herein by reference.

### TECHNICAL FIELD

The present disclosure relates to the field of propulsion devices.

### BACKGROUND

Many attempts have been made in the prior art to convert an easily generated centrifugal force (i.e. by means of a rotating power source such as an electric power source) into a linear force, and therefore into linear displacement, by restraining or directing a revolving mass. In general, the magnitude of the generated centrifugal force is proportional to the mass, the radius of gyration, and the square of the angular velocity.

While the mass is revolving about a center, an unbalanced centrifugal force may be generated in one direction by changing the radius of gyration within one sector of the curved path. Thus, a first magnitude of centrifugal force will be generated within the first sector and a second magnitude of centrifugal force will be generated within a second sector. The magnitude of the resultant unbalanced centrifugal force will thus be equal to the difference between the first and second magnitudes, when the two sectors are separated by 180 degrees.

Some prior art centrifugal force converting apparatuses, such as those disclosed in CA 2 816 624 and US 2011/0041630, provide a rotational mechanism that produces reciprocating translation. The change in direction results in a momentum transfer that disadvantageously reduces the magnitude of a propulsion force derived from the generated centrifugal force.

It would therefore be desirable to provide an apparatus for converting a centrifugal force to a unidirectional linear force that is conducive in propelling a vehicle in a desired direction.

GB 2 078 351 discloses a device with a pair of arms counter rotating about a common axle at an equal rotational speed. One arm carries a mass in the form of two weights, one of which is transferable to the other arm and back again at 180° intervals where the arms pass each other. As a result, the centrifugal force of the mass is converted to a linear force that moves the device along the rails. One disadvantage of this device is that a complicated weight transfer mechanism needs to be employed to produce an unbalanced force during half of the circular path of both arms.

U.S. Pat. No. 5,388,470 discloses a centrifugal force drive machine for generating force in a controlled direction that includes a machine frame with a shaft mounted for rotation about its axis. At least one mass is mounted on the shaft for rotation. Each mass has a center of gravity which is moveable radially with respect to the shaft between the position in which the mass is rotationally balanced about the shaft and a position in which the mass is unbalanced. A control member in an operative connection between the mass and the frame is provided to constrain radial movement of the mass between the balanced position and the unbalanced position during each revolution. When a mass is in the unbalanced position, the centrifugal force generated by the rotation of the mass is transmitted to the control member, thereby generating a linear force in the controlled direction.

In some embodiments, the control member of U.S. Pat. No. 5,388,470 includes an opening in the machine frame that is bounded by a continuous track that is offset in the controlled direction from the center of rotation of the shaft. A first mass is mounted on the shaft for rotation at a constant radius, and a second mass is mounted on the shaft for rotation at a variable radius of rotation, so that the rotation becomes unbalanced and a centrifugal force having a component in the controlled direction and transferred to the frame is generated when the second mass travels through the portion of the track which lies in the controlled direction. The rotation is balanced when the second mass travels over the remainder of the track where the center of rotation of the two masses substantially coincide. However, the magnitude of the unidirectional linear force that is generated from the centrifugal force is disadvantageously reduced due to the angular acceleration that the second mass experiences as it undergoes rotation at a variable radius of rotation.

US 2005/0160845 discloses a mass retentive linear impeller for converting rotational energy into directional linear energy induced motion, which comprises a plurality of tracks with a plurality of torque carriages slidably attached to the tracks. The torque carriages include two counter-rotating flywheels, and two rotating arms are attached to a central axis of the flywheel. A weight is located at the distal end of each rotating arm to induce a centrifugal force that is converted into forward thrust for a vehicle when a carriage pawl is releasably engaged to ratchet teeth of the tracks. Side-to-side motion is neutralized by the counter-rotating flywheels and backward motion is neutralized by allowing the carriage to slide back along the tracks. The magnitude of the unidirectional linear force generated by this apparatus is also reduced by having to periodically engage the carriage pawl, resulting in a dissipation of kinetic energy.

It is an object of the present disclosure to provide an apparatus that optimizes the conversion of generated centrifugal force to a unidirectional force without need of large-magnitude torque or a complicated weight transfer mechanism. It is an additional object of the present disclosure to provide a centrifugal force converting apparatus that employs a single mass for generating the centrifugal force. Other objects and advantages of the disclosure will become apparent as the description proceeds.

### SUMMARY

The present disclosure provides a centrifugal force converting apparatus that may include a curvilinear, variable-radius continuous track along which a single weighted roller is urged to traverse during rotation of a vertical shaft; a displaceable platform connected to the track; a linear guide connected to the shaft along which a carriage connected to the roller is slidable; and a speed controller for controllably varying rotational speed of the shaft, wherein the track may be configured with a plurality of different sectors, such that centrifugal force generated during revolving advancement of the roller along the track may increase from a minimal value at a first sector at which the center of mass of the carriage substantially coincides with the shaft to a maximum value at a second sector at which the center of mass of the carriage may be separated from the shaft by a maximum value, and may be reduced from the second sector to the first sector in response to a reduction in shaft speed caused by the speed controller, and wherein the generated centrifugal force may be transmitted to the platform via the roller and may be converted thereby to a propelling force to unidirectionally propel the platform.

The apparatus may be preferably configured to convert the generated centrifugal force to a non-regressive propelling force, which may be a linear propelling force or a rotary propelling force. The apparatus may undergo non-planar motion.

In one aspect, the first sector may include a constant-radius segment of a relatively short radius from the shaft, and the second sector may include a constant-radius segment of a relatively long radius from the shaft, to facilitate advancement of the roller along the first and second sectors without being subjected to angular acceleration. The constant-radius segment of the first sector may include a peripheral length which may be significantly shorter than the peripheral length of the constant-radius segment of the second sector.

In one aspect, the track may be configured with one or more varying-radius segments positioned between the first and second sectors.

In one aspect, the apparatus may further comprise a control system for synchronizing the shaft speed with an instantaneous peripheral position of the roller along the track.

In one aspect, the control system may include a controller in data communication with the motor, and one or more sensors in data communication with the controller for detecting the instantaneous peripheral position of the roller along the track, wherein the controller may be configured to maintain an angular velocity of the shaft and of the guide connected thereto at a predetermined controlled value that will cause a predetermined sector-specific centrifugal force to be generated.

The present disclosure is also directed to a method for converting centrifugal force to a unidirectional force, that may include the steps of irremovably engaging a roller with a curvilinear, continuous variable-radius track and fixedly connecting said roller to an unbalanced mass which is slidably mounted on a linear guide connected to a vertical shaft constituting a center of rotation; rotatably driving said shaft to cause said roller to undergo revolving advancement along said track, to guide said unbalanced mass and to thereby generate centrifugal force in response to an instantaneous distance of said roller from the center of rotation; synchronizing a speed of said shaft with an instantaneous peripheral position of said roller along said track to maintain an angular velocity of said shaft and of said guide connected thereto at a predetermined controlled value that will cause a predetermined sector-specific centrifugal force to be generated, such that the generated centrifugal force increases from a minimal value at a first sector of said track at which the center of mass of said unbalanced mass substantially coincides with said shaft to a maximum value at a second sector said track at which the center of mass of said unbalanced mass may be separated from said shaft by a maximum value, and may be reduced from the second sector to the first sector in response to a reduction in shaft speed; and transmitting the generated centrifugal force, via said roller, to a displaceable platform connected to said track and to thereby unidirectionally propel said platform.

### BRIEF DESCRIPTION OF THE DRAWINGS

FIG. 1 is a plan view of centrifugal force converting apparatus according to one embodiment of the present invention, showing a guiding rail at a starting position;

FIGS. 2-5 are plan views of the apparatus of FIG. 1 at subsequent angular positions of the guiding rail;

FIG. 6 is a plan view of the apparatus of FIG. 1, showing transitional regions A-E of the track;

FIG. 7 is a plan view of the apparatus of FIG. 1 that includes a pair of transportation rails that may guide the transmitted centrifugal force into a unidirectional linear force;

FIG. 8 is a plan view of two substantially identical and substantially synchronized apparatuses of FIG. 1 that are used together to generate a unidirectional linear force;

FIG. 9 is a block diagram of a control system operating in conjunction with the apparatus of FIG. 1;

FIG. 10 is a graph illustrating an exemplary work cycle for a speed controller operating in conjunction with the apparatus of FIG. 1;

FIG. 11 is a perspective view of components of a centrifugal force converting apparatus according to another embodiment of the invention;

FIG. 12 is a perspective view from above of a platform which is configured with a plurality of separate curvilinear tracks, each of which is adapted to cooperate with corresponding apparatus of FIG. 11;

FIG. 13 is a perspective view from above of the platform of FIG. 12 showing a plurality of centrifugal force converting apparatuses in cooperation with each of its tracks;

FIG. 14 is a perspective view from above of the kinematic connection between an electric motor and the corresponding input shaft of each speed controller of the centrifugal force converting apparatus of FIG. 13, shown without the platform;

FIG. 15 is a side view of FIG. 14;

FIG. 16 is a perspective view from above of a stand and of the platform of FIG. 12 being mounted on top of the stand;

FIG. 17 schematically illustrates an exemplary internal structure of the speed controller of FIG. 14;

FIG. 18 is a side view of FIG. 16;

FIG. 19 is a perspective view from above of a stand and of the platform of FIG. 13 being mounted on top of the stand; and

FIG. 20 is a side view of FIG. 19.

### DETAILED DESCRIPTION

Specific exemplary embodiments of the inventive subject matter now will be described with reference to the accompanying drawings. This inventive subject matter may, however, be embodied in many different forms and should not be construed as limited to the embodiments set forth herein; rather, these embodiments are provided so that this disclosure will be thorough and complete, and will fully convey the scope of the inventive subject matter to those skilled in the art. In the drawings, like numbers refer to like elements. It will be understood that when an element is referred to as being “connected” or “coupled” to another element, it can be directly connected or coupled to the other element or intervening elements may be present. As used herein the term “and/or” includes any and all combinations of one or more of the associated listed items.

It should be initially understood that all of the features disclosed herein may be combined in any combination, except combinations where at least some of such features and/or steps are mutually exclusive.

According to some embodiments, the apparatus of the present disclosure may transmit a generated centrifugal force to a platform to which a track may be connected, which may cause the platform to undergo motion in a desired direction. As will be described hereinafter, the apparatus may be configured to generate a centrifugal force in a positive direction when a revolving roller moves through certain sectors of the track, and may be prevented from generating a centrifugal force in a negative direction when the revolving roller moves through other sectors of the track. Accordingly, the platform may advance in a desired unidirectional direction with an advantageously efficient rate of conversion from centrifugal force to linear force. A propelled vehicle comprising the presently disclosed apparatus may include a wheeled vehicle, a tracked vehicle, a marine vehicle, a submarine vehicle, an airborne vehicle, and/or a space vehicle, among others.

In one embodiment, the revolving roller may have at least two functions. A first function may be to define a magnitude of the generated centrifugal force according to a distance of the roller from the center of rotation and by the path that the roller follows as it is displaced along the track and guides an unbalanced mass. A second function may be to serve as a mechanism by which the generated centrifugal force may be transmitted to the platform.

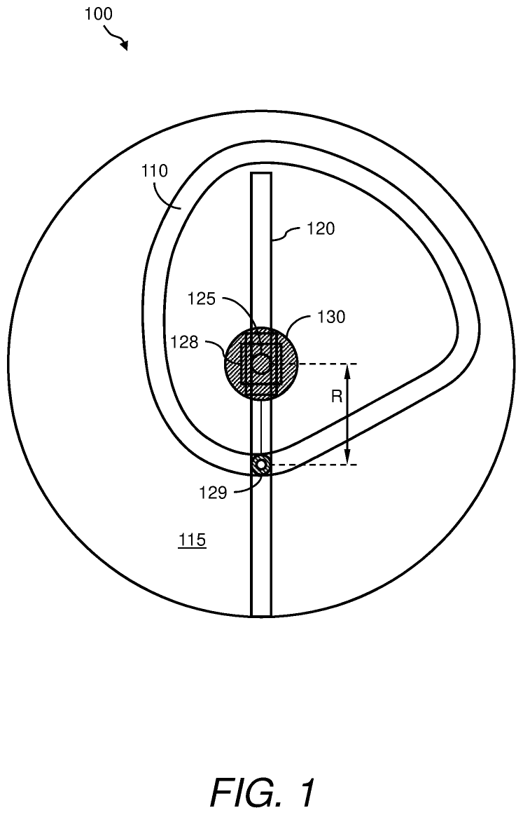

Referring now to FIG. 1, an exemplary centrifugal force converting apparatus 100 according to one embodiment of the present disclosure is presented, which may be adapted to interact with a curvilinear track 110 on a platform 115, and to convert a centrifugal force into a linear force.

In some embodiments, apparatus 100 may include an elongated roller-positioning rail 120 that may function as a linear guide overlying track 110. In some embodiments, rail 120 may be coupled to a central portion of apparatus 100 that includes a shaft 125 via one or more brackets 128. Shaft 125 may, in some embodiments, constitute a center of rotation. A carriage mass 130 may have a pre-determined or configurable mass and may be slidably coupled to rail 120. A roller 129 may be coupled to carriage mass 130 and configured to engage with track 110. Although not shown in FIG. 1, shaft 125 may be rotatably driven by a rotating power source such as a motor, and in some embodiments may be coupled with a gearbox having a plurality of gear ratios. Carriage 130 is illustrated in FIG. 1 having a substantially circular cross section, but it will be appreciated that any other shape is also within the scope of the present disclosure.

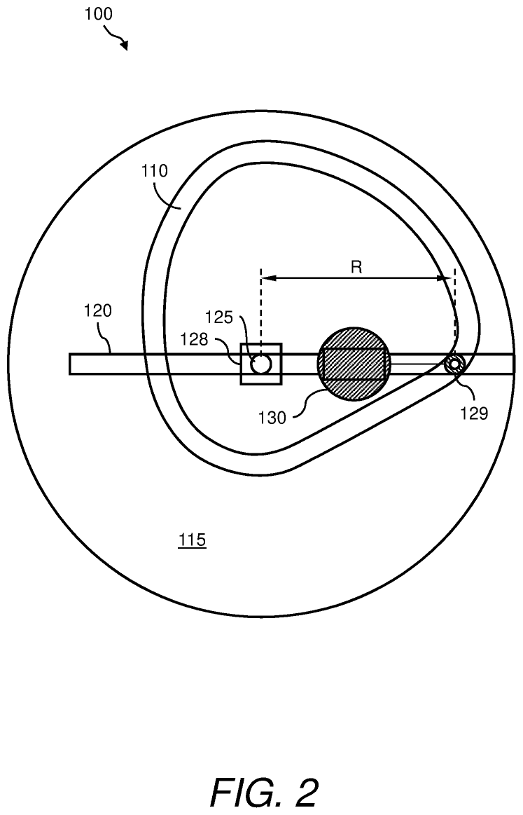

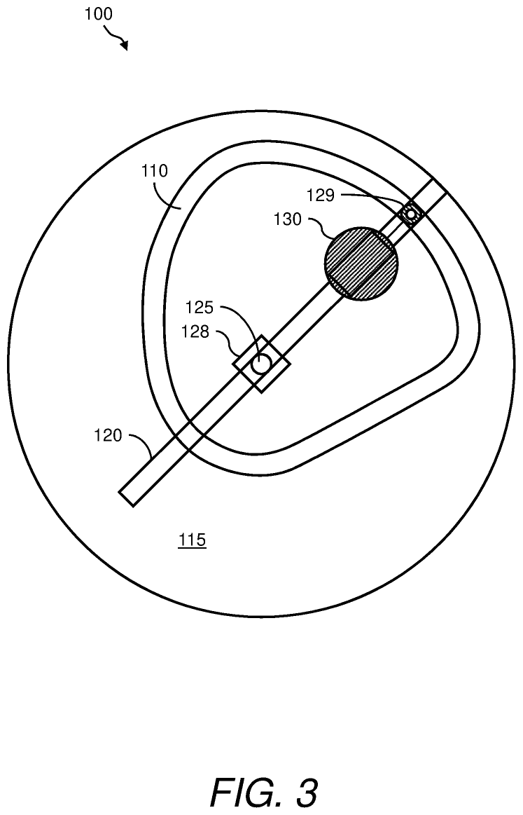

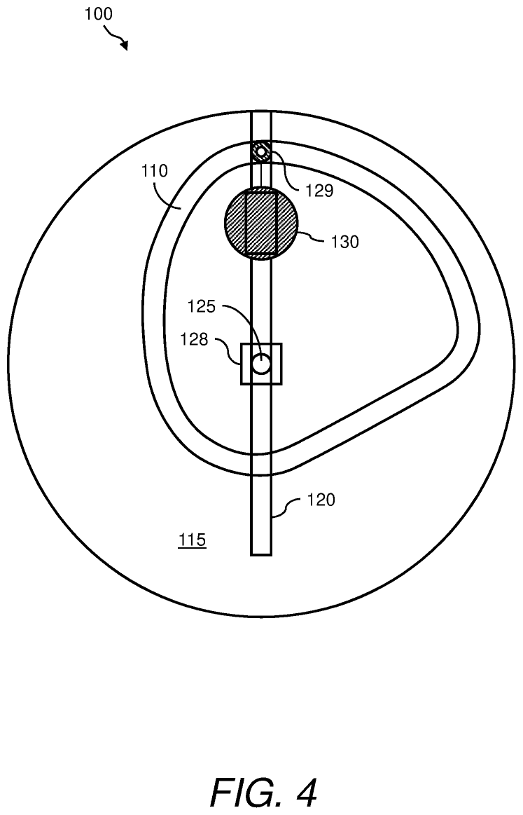

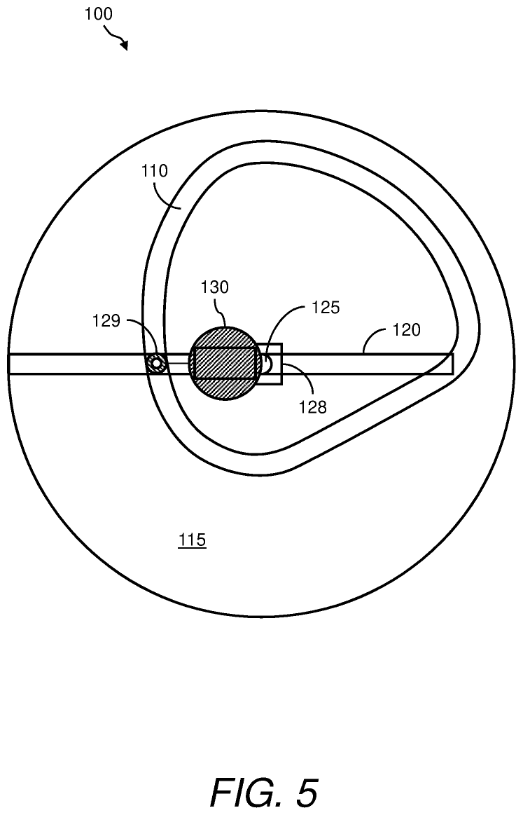

With the rotation of shaft 125, roller-positioning rail 120 may also rotate. As illustrated, for example, in FIGS. 1-6, shaft 125 and roller-positioning rail 120 may rotate in a counterclockwise direction through the various orientations depicted in FIGS. 1-6 (though rotation in a clockwise direction is also possible). For example, a starting position illustrated in FIG. 1 may have the center of mass of carriage 130 substantially coinciding with shaft 125. As track 110 may be configured with a non-uniform curvilinear periphery, the radial distance between roller 129 and shaft 125 may vary, depending on the instantaneous peripheral position of roller 129 along track 110. For example, the radial distance R between roller 129 and shaft 125 may be greater in FIG. 2 than in the starting position of FIG. 1. In addition, carriage 130 may coupled to roller 129 such that carriage 130 may be axially displaced along the roller-positioning rail 120 in like manner to any change in radial distance between roller 129 and shaft 125. Consequently, the radius of gyration from shaft 125 to the center of mass of carriage 130, which thereby influences the magnitude of the generated centrifugal force, varies as roller 129 revolves about shaft 125. As noted above, track 110 may be coupled to or inscribed in platform 115, which may surround track 110. Accordingly, the generated centrifugal force may be transmitted via roller 129 to platform 115, which may advantageously cause the latter to be linearly displaced in a forward, non-regressing direction.

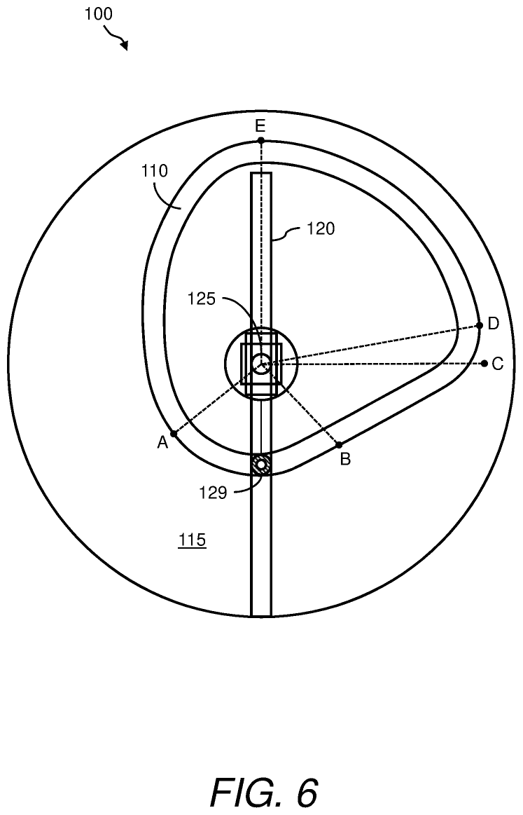

One aspect of the disclosure that may be advantageously varied is the configuration of the track (e.g., track 110) to which the revolving roller (e.g., 129) may be coupled. As shown in FIG. 6, for example, a continuous curvilinear, multi-segmented track 110 may include a plurality of segments, such that the curvature of the track may change from one adjacent segment to another. Each segment may include a peripheral portion of track 110, which may be defined by a peripheral length between two transitional track regions and may generally be characterized by a radial length or a range of radial lengths from a center of rotation about, for example, shaft 125, and by an angular “sector” that may correspond to an angular distance with respect to center of rotation about shaft 125 between the transitional regions. Each transitional region of track 110 from one segment to another may be denoted by a letter (e.g., A-E), and therefore a segment or a sector may be referred to by a combination of two letters (e.g., segment A-B, B-C, C-D, etc.).

Generally, and with reference to FIG. 6, track 110 may be configured in some embodiments with two constant-radius segments, a first relatively short constant-radius segment A-B and a second relatively long constant-radius segment D-E. Such a configuration may serve to minimize the angular accelerations of roller 129 about shaft 125 that might otherwise reduce the magnitude of the generated centrifugal force. Other segments may also be generally provided to ensure continuity of curved track 110. As illustrated, track 110 may, in some embodiments, have three variable-radius segments B-C, C-D and E-A.

The configuration of each transitional region may depend on various factors such as the size of the vehicle or vessel to be propelled, the desired speed of the propelled vehicle or vessel, and the strength of the materials used in the apparatus, among others. By way of just one example, apparatus 100 may have a sector A-B of 30°, a sector B-C of 80°, a sector C-D of 20°, a sector D-E of 80°, and a sector E-A of 150°. An exemplary apparatus 100 may also have a carriage 130 with a mass of 2 kg and a rail 120 and track 110 corresponding to a change in radius of gyration ranging from 8 cm to 16 cm. Segment E-A may also be semielliptical with a ratio of major axis to minor axis of 2 to 1.

The magnitude of the generated centrifugal force may be modeled by the following relation: F_{c}=mω²r, where F_{c} is the generated centrifugal force, m is the mass of carriage 130, w is the angular velocity of the center of mass of carriage 130 about shaft 125, and r is the radius of gyration of the center of mass of carriage 130. Thus, the magnitude of the centrifugal force will be reduced when roller 129 moves within sector A-B because the radius of gyration is relatively short, and may even be equal to 0 when the center of mass 130 coincides with the center of rotation of shaft 125. In like manner, the magnitude may be increased when roller 129 moves within sector D-E since the radius of gyration may be relatively long. If the apparatus 100 is characterized by non-planar motion, the center of mass may be replaced by a center of gravity.

A parameter that may be more influential in controlling the magnitude of the generated centrifugal force, however, is angular velocity, as the generated centrifugal force is proportional to the square of the angular velocity. Accordingly, the magnitude of the centrifugal force may remain constant when roller 129 moves within a short-radius sector (e.g., sector A-B) so long as the relative angular velocity were increased.

It has now been discovered that a non-regressive linear propelling force may be provided by generating a cyclical, sector-specific centrifugal force upon reducing the speed of shaft 125 when roller 129 moves within a reduced-radius segment and increasing the speed of shaft 125 when roller 129 moves within an increased-radius segment. The generated negative centrifugal force that would cause the platform to be propelled in a rearward direction may then be negligible, or even nonexistent, when roller 129 moves within a reduced-radius segment and the speed of shaft 125 is minimized, resulting in non-regressive movement of platform 115. As referred to herein, “non-regressive movement” may occur when the magnitude of generated negative centrifugal force is no more than 10% of the magnitude of maximally generated positive centrifugal force. On the other hand, a positive centrifugal force may be generated when roller 129 moves within an increased-radius segment and the speed of shaft 125 is increased.

In order to generate a cyclical, sector-specific centrifugal force, the speed of shaft 125 may be a function of the instantaneous peripheral position of roller 129 along track 110. Accordingly, a centrifugal force of maximal magnitude may be generated, for example, when roller 129 is positioned within the relatively long, constant-radius segment D-E, to maximize conversion of the generated centrifugal force to a linear force for propelling the vehicle, since the roller is not subjected to angular acceleration while undergoing rotation at a constant radius of rotation. Similarly, a centrifugal force of minimal magnitude may be generated when roller 129 is positioned within the relatively short, constant-radius segment A-B. Yet, roller 129 may not become stalled even though the speed of shaft 125 may be set to a minimal value in this segment since the roller may not be subjected to angular deceleration which could cause its speed to be excessively low while undergoing rotation at a constant radius of rotation.

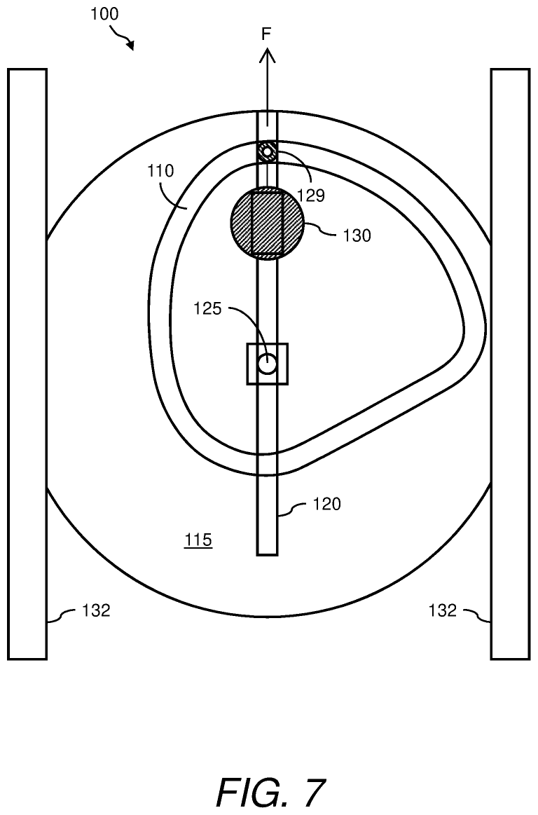

In some embodiments, apparatus 100 may be disposed along a pair of transportation rails 132 like those illustrated, for example, in FIG. 7. When platform 115 is slidably displaceable along the rails 132, the transportation rails may guide platform 115 in a direction of unidirectional force F resulting from the transmitted centrifugal force.

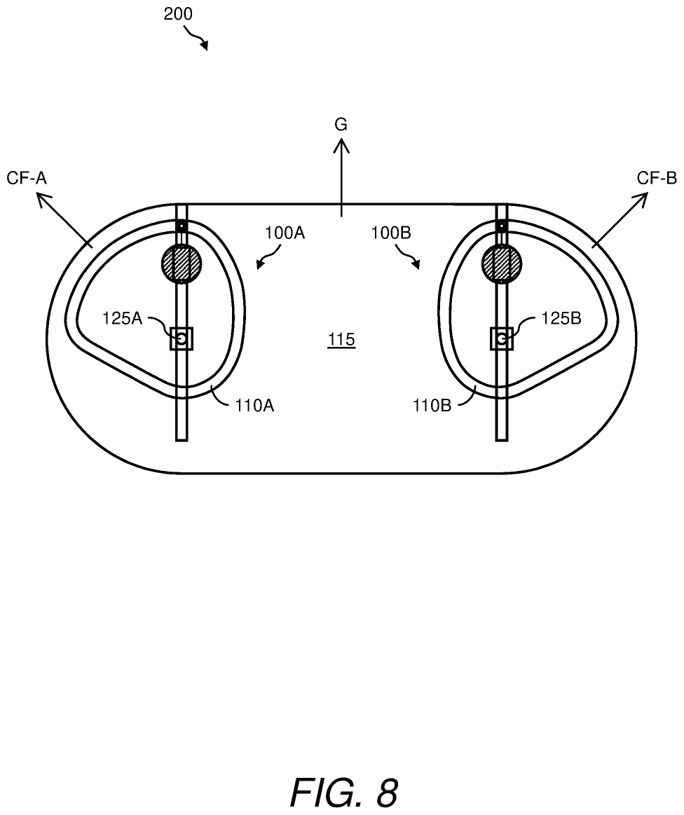

Referring now to FIG. 8, an apparatus 200 is presented according to another embodiment of the present disclosure. In some embodiments, apparatus 200 may include two or more substantially identical and substantially synchronized centrifugal force converting apparatuses 100A and 100B disposed on a common platform 115. According to some embodiments, apparatus 200 may be used for generating a unidirectional linear force G. The shaft 125 of each of apparatuses 100A and 100B may rotate in opposite rotational directions, and the corresponding transversal component of the generated centrifugal forces CF-A and CF-B may therefore be directed in opposite directions, thereby cancelling each other. The longitudinal component of the generated centrifugal forces, i.e. in the forward direction, may be additive to produce unidirectional linear force G in a desired direction.

It will be appreciated that any other number of centrifugal force converting apparatuses may be employed to produce a resultant force that will cause a platform to be propelled non-regressively in a desired linear or rotary direction.

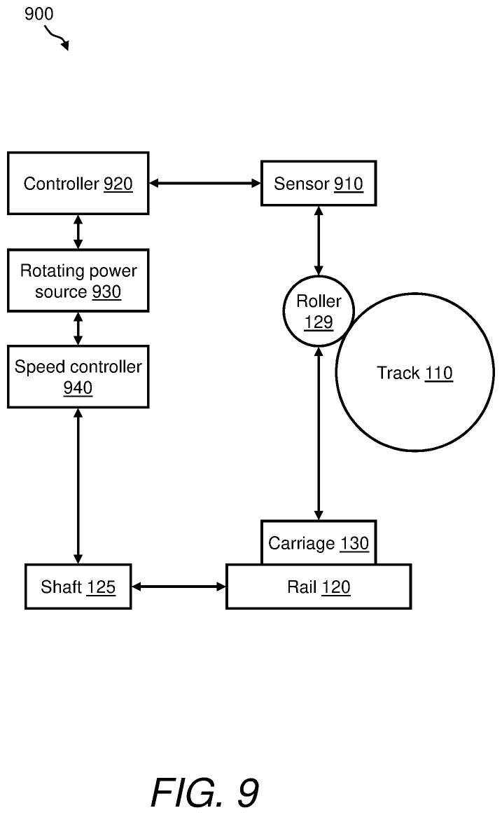

FIG. 9 schematically illustrates one embodiment of an exemplary control system 900 for synchronizing the speed of shaft 125 with the instantaneous peripheral position of roller 129 along track 110 according to the present disclosure. Control system 900 may include one or more sensors 910 for detecting the instantaneous position of roller 129 along track 110, e.g. non-contact inductive-type proximity sensors. Each of sensors 910 may be in data communication with a controller 920, and controller 920 may be in data communication with rotating power source 930, such as for example a motor. The speed of rotating power source 930 may be commanded by the controller 920 and selectively adjusted by a speed controller 940. In some embodiments, speed controller 940 may act to slow rotating power source 930 based on the instantaneous position of roller 129, so as to, for example, maintain the angular velocity of shaft 125 and roller-positioning rail 120 connected thereto at a predetermined value that may cause carriage 130 to generate a predetermined sector-specific centrifugal force after sliding along roller-positioning rail 120.

Rotating power source 930 may be commanded to generate a sufficient amount of torque so that the center of mass of carriage 130 may rotate at a sufficiently high angular velocity to generate a predetermined centrifugal force, in addition to the torque utilized by roller 129 to undergo angular acceleration when revolving along a variable-radius segment as provided by the following relation: τ_{A}=Iα, where τ_{A} is the torque acting on roller 129 as a result of undergoing angular acceleration, I is the rotational inertia of roller 129, and α is the angular acceleration of roller 129 when undergoing rotary motion with respect to a given segment. When roller 129 is displaced about a constant-radius segment, it is not angularly accelerated and the value of τ_{A} is equal to zero.

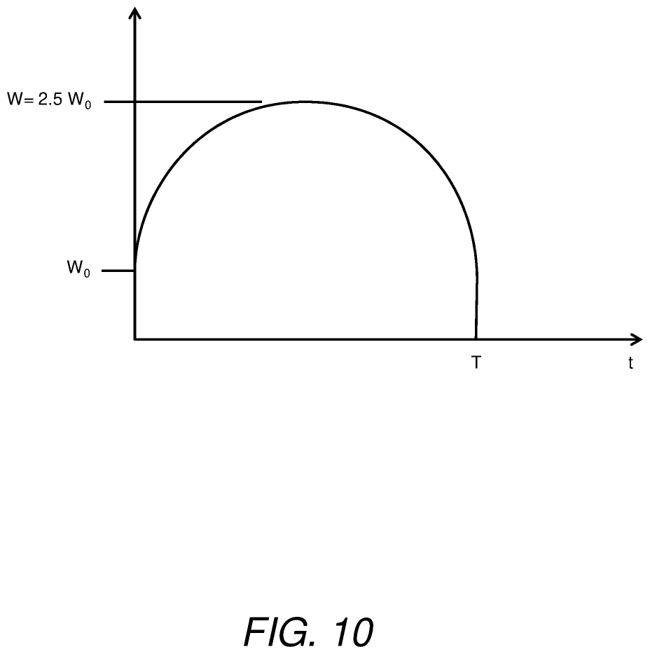

Speed controller 940 may include one or more gears with one or more possible gear ratios. The instantaneous gear ratio of speed controller 940 may define the speed of shaft 125, and thus the kinetic energy of carriage 130 and roller 129, as well as the magnitude of the generated centrifugal force. FIG. 10 illustrates an exemplary work cycle for speed controller 940 during a cycle T by which a pinion speed W has a starting speed Wₒ at the start of the cycle, i.e. corresponding to the instantaneous roller position at a central region of sector A-B, and steadily increases until achieving a maximum value of, for example, 2.5 times Wₒ at the instantaneous roller position corresponding to transitional region E to generate the maximal value of centrifugal force. While the pinion speed steadily increases, the control system ensures that the linear propelling force converted from the generated centrifugal force will be non-regressive. Rotating power source 930 may then be deactivated when the instantaneous roller position is within sector E-A, causing the pinion speed to steadily decrease to a value of 0 at the central region of segment A-B. It should be noted however that roller 129 may continue to revolve about the center of rotation even though rotating power source 930 has been deactivated, by virtue of the kinematic energy with which roller 129 has been imparted at transitional region E, although roller 129 may decelerate within sector E-A. During movement of roller 129 within sector E-A, the generated centrifugal force is negligible or nonexistent even though roller 129 continues to revolve since the center of mass of carriage 130 substantially coincides with shaft 125. Another cycle commences when rotating power source 930 is reactivated at the central region of sector A-B.

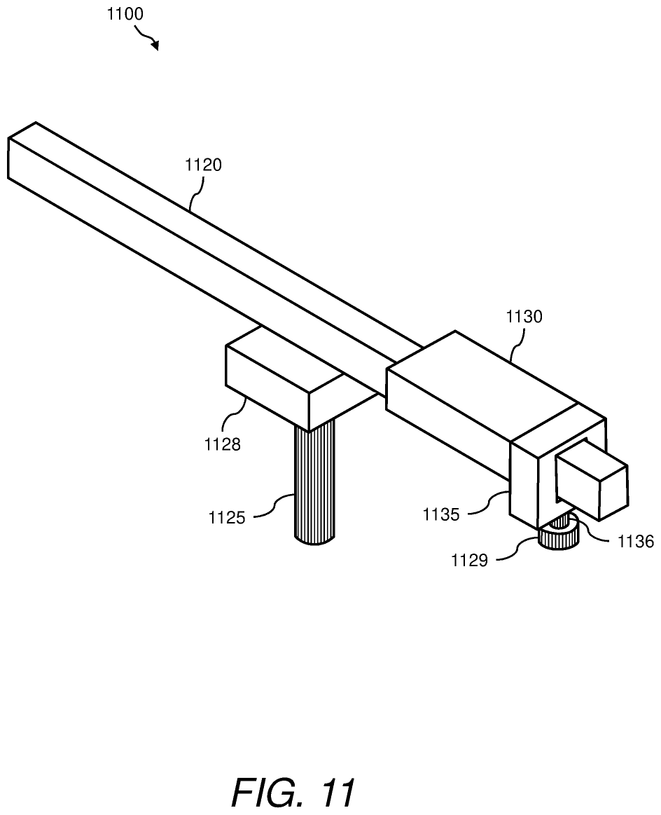

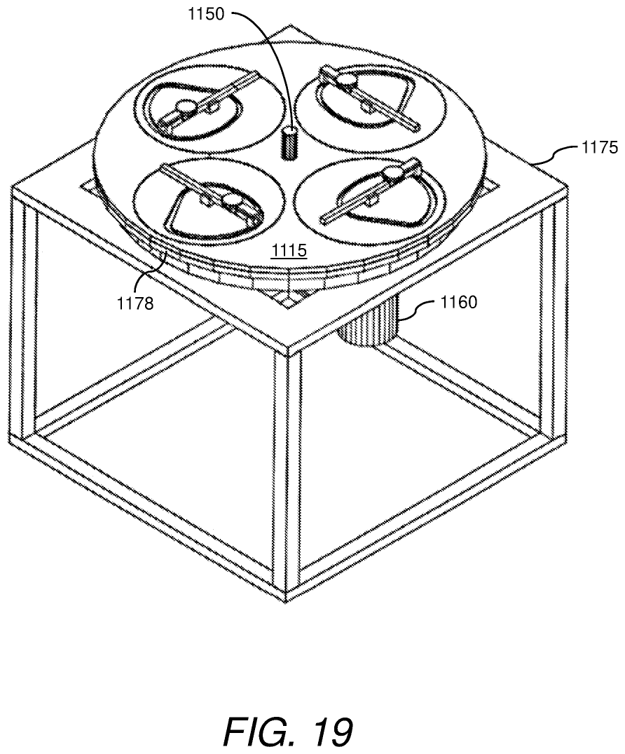

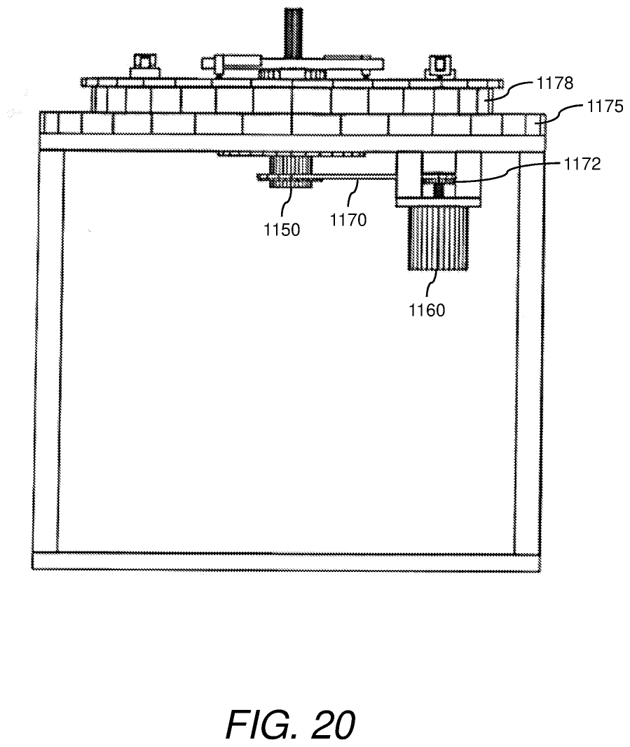

FIGS. 11-20 illustrate another embodiment of a centrifugal force converting apparatus employing an electric motor according to the present disclosure. Referring now to FIG. 11, an exemplary centrifugal force converting apparatus 1100 is presented. Centrifugal force converting apparatus 1100 may include a rectilinear carriage 1130 that is slidable along elongated roller-positioning rail 1120 that may be rigidly coupled to a central region thereof by a rectilinear bracket 1128 to shaft 1125. A rectilinear roller carrier 1135 may be coupled to a radially outward end of carriage 1130, and may in some embodiments surround roller-positioning rail 1120 and may extend downwardly form carriage 1130. A bottom surface of roller carrier 1135 may be coupled to a shaft 1136 that in turn is coupled to a roller 1129. Roller 1129 may be configured to engage with a curvilinear track.

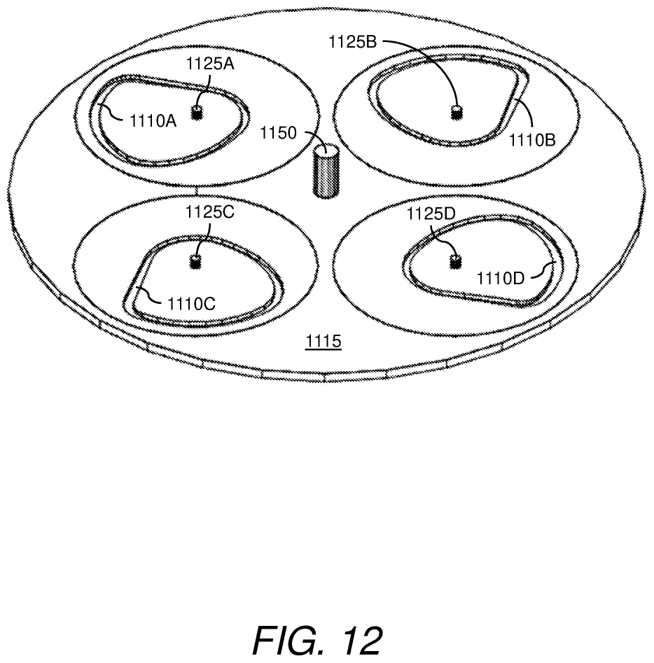

Referring now to FIG. 12, an exemplary circular platform 1115 having four separate curvilinear tracks 1110A-D is presented. Tracks 1110 A-D may each have a shape comparable to track 110 illustrated, for example, in FIGS. 1-6, though other configurations are possible. In some embodiments, tracks 1110 A-D may be recessed from an upper surface of platform 1115. The presence of a plurality of tracks may allow for each corresponding centrifugal force converting apparatus provided therewith to sequentially transmit a linear force to platform 1115, thereby applying a substantially continuous propulsion. In another embodiment, two or more apparatuses may simultaneously transmit a linear force in different directions to induce a rotational force to the platform 1115. A vertically oriented central shaft 1150 that may be driven by a motor may be positioned at, and protruding through, a center of platform 1115, and may be kinematically connected to, or otherwise coupled or connectable with, shafts 1125 A-D that may be positioned within an interior of a corresponding track 1110A-D and protruding through platform 1115.

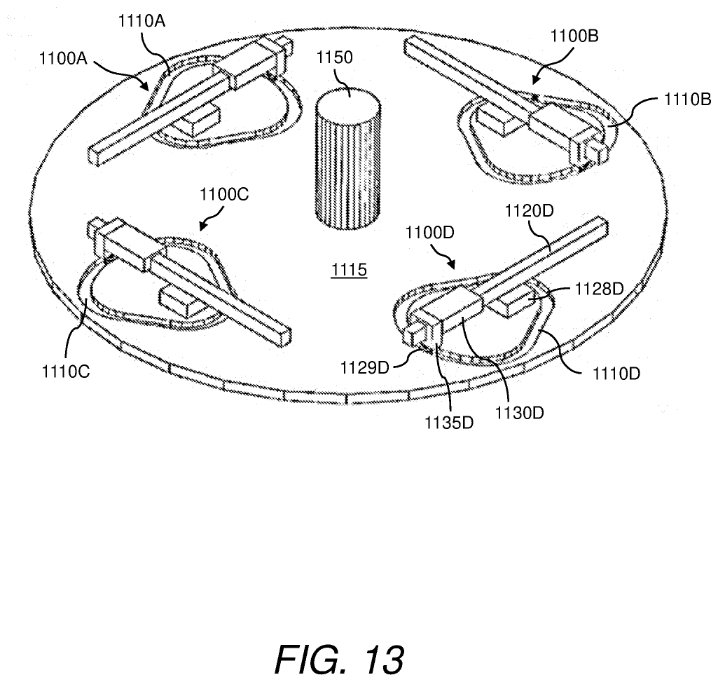

Referring now to FIG. 13, corresponding apparatuses 1100 A-D are presented in general relation to each corresponding track 1110 A-D. In some embodiments, roller-positioning rails 1120A-D may rotate with a corresponding shaft 1125 (FIG. 11), and rollers 1129 may engage with a corresponding track 1110 A-D, and a carriage 1130 may be slidable along a corresponding roller-positioning rail 1120.

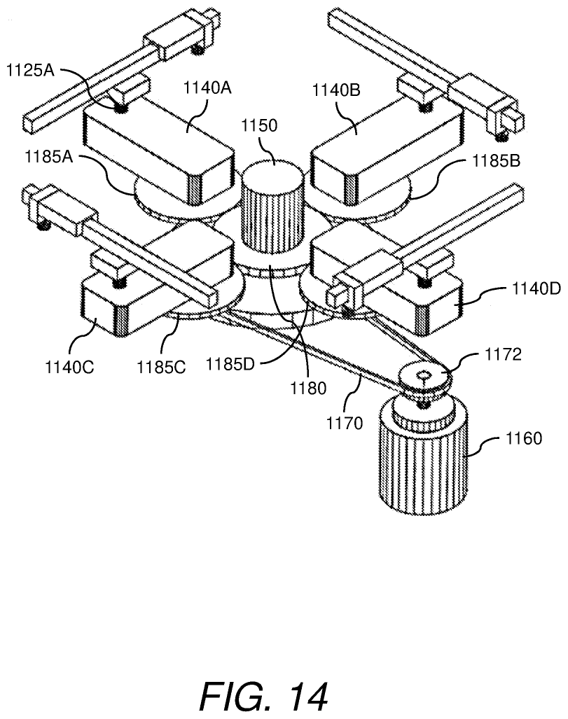

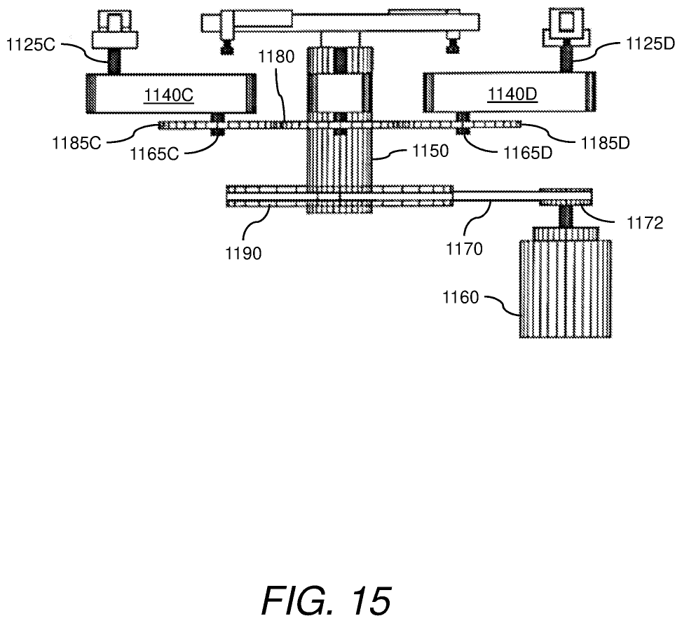

FIGS. 14-15 and 20 illustrate a two-stage kinematic connection between an electric motor 1160 and the corresponding input shaft 1165A-D (FIG. 15) of each speed controller 1140 A-D. A belt 1170 engaged with sprocket 1172 connected to the output shaft of motor 1160 may transmit generated torque to the central shaft 1150. The torque from central shaft 1150 may be transmitted in turn to each input shaft 1165A-D (FIG. 15) of a corresponding speed controller 1140 A-D by a central gear 1180 concentric with central shaft 1150 and by a peripheral gear 1185 A-D intermeshed with central gear 1180 and mounted on the corresponding input shaft 1165 A-D of each speed controller 1140 A-D. A flywheel 1190 may be mounted on central shaft 1150 to store the rotational energy.

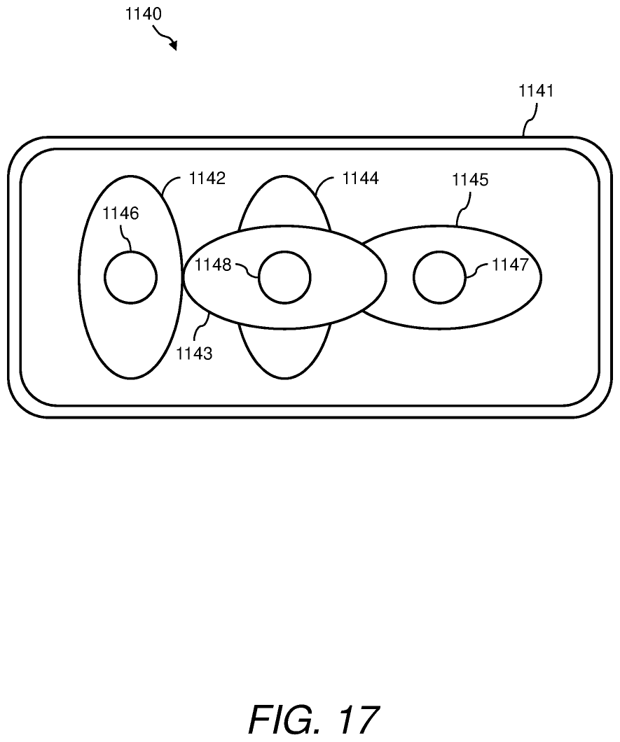

FIG. 17 schematically illustrates one embodiment of a speed controller 1140 having, for example, a casing 1141 and further having variable gear ratios. Speed controller 1140 may include four ellipsoidal gears 1142, 1143, 1144 and 1145. While gears 1142 and 1145 may be rotatably mounted on shafts 1146 and 1147, respectively, gears 1143 and 1144 are mounted on common shaft 1148.

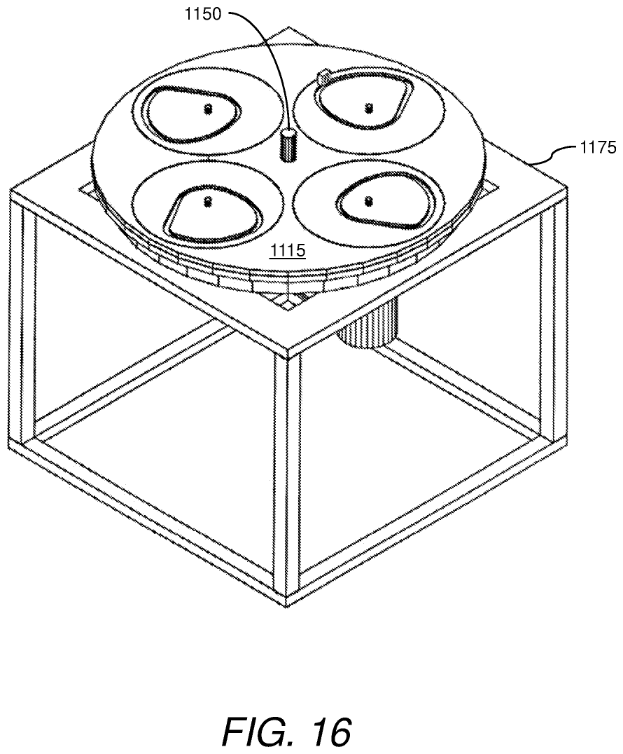

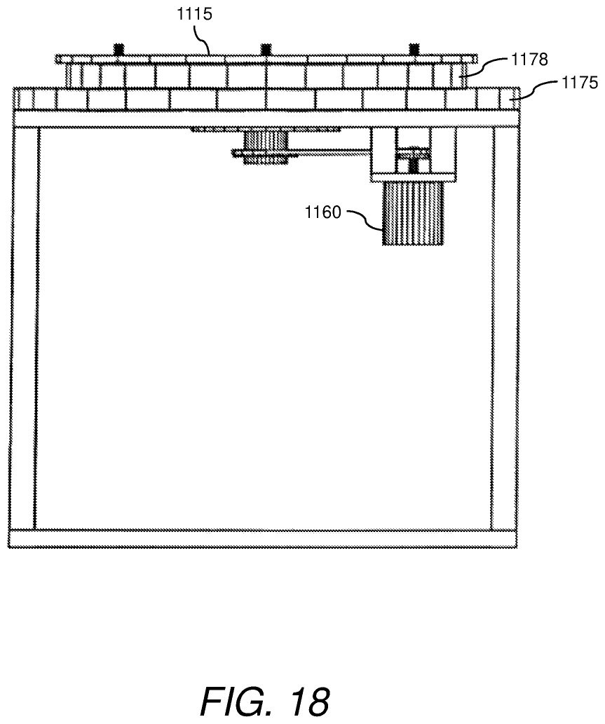

As shown in FIGS. 16, 18 and 19, circular platform 1115 may be mounted on top of a rectilinear stand 1175. The bottom of stand 1175 may be equipped with wheels, e.g. caster wheels, or other means of reducing friction (e.g., sliders, ball bearings, magnetic levitation, water, etc.) to allow the stand 1175 to be propelled by the transmitted linear force. In another embodiment, stand 1175 may be stationary and platform 1115 may be rotatable about central shaft 1150 at a different speed. The rotary movement of platform 1115 may be facilitated by annular bearing 1178 (FIG. 18).

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

That which is claimed:

1. A centrifugal force converting apparatus, comprising:
a) a curvilinear, variable-radius continuous track along which a roller is adapted to traverse during rotation of a vertical shaft;
b) a displaceable platform coupled to the track;
c) a linear guide coupled to the shaft and a weighted carriage coupled to the roller, wherein the weighted carriage is slidable along the shaft; and
d) a speed controller for varying a rotational speed of the shaft,
wherein the track comprises a plurality of sectors, such that centrifugal force generated during revolving advancement of the roller along the track increases from a minimal value at a first sector at which the center of mass of the carriage substantially coincides with the shaft to a maximum value at a second sector at which the center of mass of the carriage is separated from the shaft by a maximum value, and is reduced from the second sector to the first sector in response to a reduction in shaft speed caused by the speed controller, and
wherein the generated centrifugal force is transmitted to the platform via the roller and is converted thereby to a propelling force to unidirectionally propel the platform.

2. The apparatus according to claim 1, wherein the centrifugal force converting apparatus is configured to convert the generated centrifugal force to a non-progressive propelling force.

3. The apparatus according to claim 2, wherein the centrifugal force converting apparatus is configured to convert the generated centrifugal force to a non-regressive linear propelling force.

4. The apparatus according to claim 2, wherein the first sector comprises a constant-radius segment of a relatively short radius from the shaft, and the second sector comprises a constant-radius segment of a relatively long radius from the shaft, to facilitate advancement of the roller along the first and second sectors without being subjected to angular acceleration.

5. The apparatus according to claim 4, wherein the constant-radius segment of the first sector comprises a peripheral length which is significantly shorter than the peripheral length of the constant-radius segment of the second sector.

6. The apparatus according to claim 4, wherein the track comprises one or more varying-radius segments that are positioned between the first and second sectors.

7. The apparatus according to claim 4, further including a rotating power source for rotatably driving the shaft.

8. The apparatus according to claim 7, wherein the rotating power source is a motor coupled with the speed controller for defining an instantaneous rotational speed of the shaft.

9. The apparatus according to claim 8, further including a control system for synchronizing the shaft speed with an instantaneous peripheral position of the roller along the track.

10. The apparatus according to claim 9, wherein the control system comprises a controller in data communication with the motor, and one or more sensors in data communication with the controller for detecting the instantaneous peripheral position of the roller along the track, wherein the controller is configured to maintain an angular velocity of the shaft and of the guide connected thereto at a predetermined controlled value that will cause a predetermined sector-specific centrifugal force to be generated.

11. The apparatus according to claim 10, wherein the controller is configured to reduce the shaft speed when the roller advances along the track at the first sector and to increase the shaft speed when the roller advances along the track at the second sector to ensure that the propelling force is non-regressive.

12. The apparatus according to claim 9, further comprising two or more force converting units, wherein each of the force converting units comprises a corresponding shaft, track, guide and speed controller configured such that the platform is connected to each of the corresponding tracks, and wherein the control system is configured to synchronize the operation of each of the corresponding shafts.

13. The apparatus according to claim 12, wherein the shaft of each of the two force converting units rotates in opposite rotational directions and a transversal component of the corresponding generated centrifugal forces are of an equal and opposite magnitude to cancel each other.

14. The apparatus according to claim 13, wherein a longitudinal component of the generated centrifugal forces is additive to produce a unidirectional linear force.

15. The apparatus according to claim 14, wherein each corresponding force converting unit is synchronized to sequentially transmit a linear force to the platform, to allow the apparatus to be continuously propelled in a desired direction.

16. The apparatus according to claim 12, wherein the centrifugal force converting apparatus converts the generated centrifugal forces to a non-regressive rotary propelling force.

17. The apparatus according to claim 3, further including a pair of parallel transportation rails along which the platform is slidably displaceable, for converting the transmitted centrifugal force into the linear propelling force.

18. The apparatus according to claim 1, wherein the centrifugal force converting apparatus undergoes non-planar motion.

19. A method for converting centrifugal force to a unidirectional force, comprising the steps of:
a) engaging a roller with a curvilinear, continuous variable-radius track and coupling the roller to an unbalanced mass which is slidably mounted on a linear guide coupled to a vertical shaft constituting a center of rotation;
b) rotatably driving the shaft to cause the roller to undergo revolving advancement along the track, to guide the unbalanced mass and to thereby generate centrifugal force corresponding to an instantaneous distance of said roller from the center of rotation;
c) synchronizing a speed of the shaft with an instantaneous peripheral position of the roller along the track to maintain an angular velocity of the shaft and of the guide connected thereto at a predetermined controlled value that will cause a predetermined sector-specific centrifugal force to be generated, such that the generated centrifugal force increases from a minimal value at a first sector of the track at which the center of mass of the unbalanced mass substantially coincides with the shaft to a maximum value at a second sector of the track at which the center of mass of the unbalanced mass is separated from the shaft by a maximum value, and is reduced from the second sector to the first sector in response to a reduction in shaft speed; and
d) transmitting the generated centrifugal force, via said roller, to a displaceable platform coupled to the track and to thereby unidirectionally propel the platform.
